(19) United States
(12) Patent Application Publication
(10) Pub. No.: US 2008/0250462 A1
(43) Pub. Date: Oct. 9, 2008

(54) Apparatus and system for connecting one electronic portable device to at least one other electronic device

(75) Inventor: Henri CROHAS, Verrieres-Le-Buisson (FR)

Correspondence Address: YOUNG & THOMPSON, 209 Madison Street, Suite 500, ALEXANDRIA, VA, 22314, US

(73) Assignee: ARCHOS S.A., Igny (FR)

(21) Appl. No.: 12/062,546

(22) Filed: Apr. 4, 2008

(30) Foreign Application Priority Data
Apr. 6, 2007 (FR) 07/02516

(51) Int. Cl. H04N 7/18

(52) U.S. Cl. 725/74

(57) ABSTRACT

The present invention relates to apparatus for connecting a multimedia portable electronic device capable of storing and playing and/or recording video in digital form, to at least one other electronic device. The apparatus further includes at least one wireless communications interface and means for implementing at least one function involving all or some of the hardware and/or programmable resources incorporated in or attached to the apparatus.

The present invention relates to apparatus for connecting a portable electronic device to at least one other electronic device, the portable electronic device being capable at least of storing digital content and of playing and/or recording video. The invention also relates to a system using such apparatus for broadcasting digital streams representing multimedia contents and/or television programs to one or more devices capable of running them within a premises or a transport means.

So-called “boxes” for making ADSL connections are known that provide, either in optional manner or as original equipment, a WiFi access point function for external equipment. Docking stations are also known for wireless portable devices enabling wired connections to be made. Also known are patents Nos. FR 03/08516 and FR 04/07172 in the name of the same inventor.

An object of the present invention is to provide novel means for connecting a portable electronic article to its environment, in particular to other complementary electronic devices that are in substantially sedentary use. The term “substantially sedentary use” is used to mean that the portable electronic device is used either at a fixed point or while mobile around said fixed point within a building or a transport means. For example, the building may be a dwelling or professional premises. The transport means may be, for example: a train, a bus, a car, an airplane, or a boat.

Another object of the invention is to provide a wireless communications capacity capable of offering a quality of service compatible with use in consuming television or digital contents representing video, music, or photos, and under the best possible conditions. In particular this requires a data rate to be available that is sufficient to satisfy the needs of applications that consume large amounts of bandwidth, such as for example broadcasting and/or transferring video contents, in particular at high definition.

Solutions of the prior art provide an answer to this problem that is partial and unsatisfactory in that the functions of wired and/or wireless connectivity are not optimized for delivering the expected quality of service on the site of consumption, and/or in that the functional combinations of the prior art do not enable most of the services that can be made available by implementing the invention to be supplied under conditions that are acceptable in terms of ergonomics, size, and/or cost.

The invention seeks in particular to make it possible to obtain a wireless connection between at least one piece of portable equipment and the apparatus of the invention, the wireless connection being arranged and optimized to provide a good quality of service in the context of use over a long duration. The term “good quality of service” is used to mean practically no artifacts that are perceptible to the user. The term “utilization for a long duration” is used to mean continuous use over at least several hours, e.g. corresponding to consuming one or more musical or video works.

At least one of the above objects is achieved with apparatus that is connectable to a portable electronic device, such as for example a portable (multi)media player or a portable media assistant, or a portable multimedia container, i.e. a device for storing multimedia contents and playing them back via a standard external device, or even a mobile telephone having means for connection to a local wireless network, e.g. a WiFi or Bluetooth network, in addition to its ability to connect with at least one infrastructure network. Portable electronic devices of the personal digital assistant type, and indeed laptop computers can also be connected to apparatus of the invention. In general, the apparatus of the invention can be used advantageously with any portable digital device requiring a supply of energy for its own operation and/or for recharging internal energy storage means. The portable devices that come most particularly into the field of the invention are capable at least of storing digital contents in a memory of not less than one gigabyte and of playing and/or recording video. The portable device may advantageously also play and/or record music and/or store photos in digital form and play them back. Advantageously, the portable device includes a wireless communications interface. The device of the invention also includes wireless transmission means on which new services and new uses are based, in particular for consuming television. By means of the apparatus of the invention, multimedia information streams can in particular be broadcast to mobile terminals and to fixed devices such as other TV sets in a dwelling, in professional premises, or in transport means.

In its system aspect for broadcasting digital streams representing television programs and/or multimedia contents, the invention can also apply to portable electronic devices that do not have any particular storage capacity beyond that needed to enable them to receive and play back appropriately a digital stream that is broadcast in so-called “streaming” mode. It also remains within the ambit of the invention to use non-portable TV sets that include means for receiving by wireless techniques, for decoding, and for playing back digital streams representing television programs and/or multimedia contents.

According to the invention, the apparatus for connecting a portable electronic device capable of storing digital content in a memory of at least one gigabyte and of playing and/or recording video to at least one other electronic device comprises:
an interface for establishing continuity of at least one signal between said apparatus and the portable electronic device and/or for transferring energy to the portable electronic device; and
at least one interface for establishing continuity of at least one signal between said apparatus and the at least one other electronic device; and
at least one wireless communications interface; and
means for implementing at least one function involving all or some of the resources implemented in said apparatus.

An interface for transferring energy to the portable electronic device relies on the continuity of at least one electrical circuit via separable means. The term “continuity of at least one electrical circuit” covers at least one means enabling an electric current to flow. They may comprise, for example, continuity of at least two mutually insulated electrical conductors or indeed, possibly, continuity of a single electrical conductor proper, with electric current return being possible by making contact with a metal portion of the portable device, e.g. an element of its housing.

Another interface for transferring energy to the portable electronic device makes use of inductive coupling. It can be particularly advantageous to transfer energy via inductor coils facing each other through touching walls of the portable device and of the apparatus. Using no electrical contact in this solution improves reliability, and safety, and also makes it possible to provide housings that are substantially waterproof.

An interface for establishing continuity of at least one signal between said apparatus and the portable electronic device relies on the continuity of at least one electrical circuit via separable means. In general, portable devices posses their own display means, sound playback means, and/or man-machine interfaces such as a keypad or a touch-sensitive screen. That said, the means they incorporate generally cannot provide quality and/or comfort of use coming anywhere close to that provided by means that are larger and/or more specific. The apparatus of the invention includes at least one interface for directing the signals concerned to external devices. Said external devices may for example be a TV set, a video projector, a hi-fi system, a multiple channel sound playback system of the home cinema type, a keyboard, etc.

The simplest separable interface is constituted by at least one pair of connectors comprising at least one electrical contact for conveying at least one signal. When there is only one contact, continuity for a reference potential can be provided by means common with those used for transferring energy and/or by making contact with a metal portion of the housing.

In a variant seeking more particularly to limit the number of electrical contacts, an interface for establishing continuity of at least one signal between said apparatus and the portable electronic device may form part of an interface for transferring energy to the portable electronic device.

Several combinations of resources are possible. When the portable electronic device does not have wireless communications means compatible with at least one wireless communications interface of the apparatus as mentioned on page 3, so-called carrier current solutions can be implemented. That involves superposing a carrier frequency on a power supply voltage which may be a direct current (DC) voltage or an alternating current (AC) voltage at low frequency, e.g. at 50 hertz (Hz), 60 Hz, 100 Hz, 120 Hz, or 400 Hz, with the carrier Frequency being for example in the 100 kilohertz (kHz) range or comprising a plurality of carrier frequencies when using so-called “spread spectrum” modulation, with the carrier frequency(ies) being modulated as a function of the information that is to be transmitted. The carrier current technique is generally used at higher voltages, but there is nothing to prevent it being used in the context of very low voltages. It makes it possible to use the same physical means both for transferring energy and for transmitting data, possibly multiplexed data, in order to establish continuity of at least one signal, and where necessary via a both-way link it is possible to ensure the continuity of at least one input signal and/or of at least one output signal.

When the portable device is fitted with wireless communications interface compatible with the interface of the apparatus, it is then possible to use said interface for providing the continuity of at least one signal.

Naturally, it is advantageous to provide continuity for a plurality of signals, e.g. analog input and/or output signals, digital input and/or output signals, and control input and/or output signals, thus enabling functionally rich co-operation to be established between the portable device and the apparatus of the invention.

Another variant interface for establishing continuity of at least one signal between said apparatus and the portable electronic device relies on the continuity of at least one optical circuit via separable means. It is advantageous to use optical means for establishing signal continuity since that makes it possible to improve performance and/or robustness and immunity for the equipment relative to electrical disturbances. By way of example, such means may be based on using plastic optical fibers, possibly using matching beads in the separable interface for increasing tolerance to fiber alignment error on either side of the interface. Radiating optical means can also be used without going beyond the ambit of the invention, for example infrared IrDA transceivers or proprietary solutions based on using optoelectronic transmitters and/or receivers using radiation that can be guided and/or confined by appropriate partitions on either side of the separable interface. Multiplexing solutions can serve to reduce the number of optical channels, where possible to one channel in each direction, by taking advantage of the very high data rate transmission capacities that are specific to optical solutions.

An interface for establishing continuity of at least one signal between the apparatus of the invention and the portable electronic device makes use of inductive coupling. Inductive coupling is particularly advantageous in that, like optical solutions, it does not involve direct electrical contact between the induction coils situated facing each other behind insulating walls. This characteristic also avoids numerous potential problems, in particular parasitic current flows or electric charge storage that might otherwise disturb the operation of electronic circuits that are becoming more and more sensitive to the environment because they operate at ever-lower voltages associated with increasing integration density, and in order to reduce energy consumption.

The advantage of the solution using transmission by inductive coupling is further reinforced if the interface for establishing continuity of at least one signal between said apparatus and the portable electronic device makes use of the same induction coils for transferring energy. Sharing the same inductors for transferring energy and data is advantageous in that it combines the advantages while saving on the means deployed. By way of example, sharing the same coils for both purposes can rely on modulating the induced current and/or the absorbed current so as to send data depending on whether data has been sent from the power supply side or from the load side. Data can be received, for example, by demodulating the carrier signal taken from the corresponding coil.

An interface for establishing continuity of at least one signal between the apparatus of the invention and the portable electronic device makes use of capacitive coupling. Capacitive coupling is advantageous in that it can provide substantially the same performance as optical solutions, while possibly being less expensive to implement. Electrodes of appropriate shape, area, and number are disposed facing one another behind insulating walls, thus enabling information to be transferred by capacitive coupling. The means implemented for embodying this interface are dimensioned so as to provide a connection, advantageously a both-way connection, with data rates appropriate in particular for the functional choices implemented in the context of performing the invention.

An interface for establishing continuity of at least one signal between said apparatus and the portable electronic device uses one or more micropower radio connections. This is an application of techniques for transmitting data by radio applied to an interface where the antennas of the transmitter(s) are very close to the antennas of the corresponding receivers). The types of antenna and their respective orientations are selected to maximize the effectiveness of the transmission channel(s), in particular by maximizing mutual isolation between antennas in order to reduce interference. All or some of the characteristics of the antennas may differ in transmission and in reception without going beyond the of the invention. Appropriate shielding is advantageously placed in the apparatus and in the portable device tending to enclose the interface in a Faraday cage so as to limit external radiation and reinforce immunity relative to sources of disturbance that form part of the wireless communications interface of the apparatus. Where necessary, internal partitioning in the shielding can enable a plurality of independent transmission channels to be implemented within the interface. Integrating the signal processing electronics and one or more antennas on that same chips for placing on either side of the interface is particularly advantageous in terms of compactness, ease of use, and expense.

The apparatus of the invention and the portable electronic device both include respective portions of the means constituting the interface 3. The interface as a whole is arranged to operate under conditions that are optimized when both items are in a particular position relative to each other, as determined by construction. This particular relative position is made stable under the effects of gravity, with at least three points of contact between the portable device and the structure of the apparatus or of an adapter part secured to said structure. The effect of gravity can also be assisted or replaced by the effect of a permanent magnetic field produced by one or more magnets, or indeed by any other mechanical means, without thereby going beyond the ambit of the invention. The use of magnets for holding the portable device on the apparatus is particularly appropriate for digital content storage solutions that do not rely on using magnetic fields, such as for example solutions based on flash memories.

Keeping the portable device in a stable position on the apparatus can require one or more degrees of freedom to be blocked by suitable guides. This is particularly necessary when using interfaces without electrical contact. A female shape forming an integral portion of the structure of the apparatus, or indeed embodied by an adapter part secured to the structure of the apparatus, and suitable for having at least a portion of the housing of the portable device inserted therein serves to receive the portable device and to guide it to the position in which it is held in stable manner. Guidance and blocking unwanted degrees of freedom can also rely on a male shape secured to the structure of the apparatus and that is received at least in part within the volume of the housing of the portable device. It would not go beyond the ambit of the invention for a plurality of particular relative positions to be made possible by construction, for example a plurality of angles of inclination in order to adjust the user's viewing angle for looking at the image on the screen of the portable device placed on the apparatus. Similarly, it is possible to arrange the mechanical and electrical interface between the portable device and the apparatus of the invention so as to provide one stable position of the “portrait” type and another stable position of the “landscape” type, by analogy with printing formats. Under such circumstances, an advantageous refinement detects which interface is active, or detects information from a position sensor in the portable device, so as to cause the image that is displayed to pivot and be presented in appropriate manner on all occasions.

An interface for establishing continuity of at least one signal between the apparatus of the invention and at least one other electronic device relies on the continuity of at least one electrical circuit via separable means. The apparatus can establish continuity of at least one signal between its internal circuits and another electronic device by means of at least one connector secured to a wall of the apparatus. The at least one connector leading to the external device may also be placed at the end of a cable, without thereby going beyond the ambit of the invention. It should be observed that in a minimum implementation of the apparatus of the invention, an external power supply unit connectable to the apparatus via at least one disconnectable connector placed at the end of a cable and/or attached to a wall of one of the two devices can be considered as another electronic device having at least one electrical circuit in continuity with the internal circuits of the apparatus via separable means.

An interface for establishing continuity of at least one signal between the apparatus of the invention and at least one other electronic device relies on the continuity of at least one optical connection in guided mode connected via separable means, and/or a connection in radiated mode. The continuity of at least one signal between the apparatus and the at least one other electronic device can rely on at least one guided and/or radiated optical connection. The term “optical connection” is used to mean a connection +that is one-way or both-way, that is possibly multiplexed in the frequency and/or the time domain, and that makes use of at least one kind of modulation of a light signal at at least one wavelength, e.g. in the near infrared, in the visible red, or in the blue. The term “guided optical connection” is used to mean a connection in which light is conveyed by means that guide its path and/or limit is radiation. For example, it is possible to use a cable including at least one optical fiber having a core made of a medium that is transparent at the wavelength(s) used and that is made of glass or of a suitable plastics material. It is also possible to use means that are designed for use in radiated mode but that are arranged so that their radiation pattern is limited in three dimensions, e.g. so as to avoid interference in transmission and/or in reception, and/or in order to enable a plurality of independent connections to be made in a space of small size. For example, partitions could be used that are arranged on the path of the signal, being secured to one and/or the other end of the connection and that also serve to position the emission and reception means facing one another while remaining separable.

Optical connections may also be based on light signals transmitted in radiated mode in direct line of sight or by reflection on walls. This can involve both-way connections such as provided by the IrDA standard, or a one-way connection, in particular for receiving infrared signals coming from a remote control and/or infrared signals emitted for controlling other electronic devices.

The separable means are attached in part in substantially rigid manner to a wall of the device. This may be done for example by any combination of male, female, or hermaphrodite connectors in which each portion is attached in substantially rigid manner to a wall of the corresponding device, while the devices continue to be separable. Naturally, it would not go beyond the invention for a plurality of connectors to be arranged so as to be connected substantially in a single movement, e.g. if all or some of the connectors are secured to flexible supports designed to absorb dimensional tolerances.

The separable means are attached in part via flexible means, possibly detachable means, to the device. This may involve, for example, connectors in which at least one of the connector portions is mounted at the end of a cable.

The at least one wireless communications interface relies on modulating at least one electromagnetic field to create a connection that is one-way, both-way, and optically multiplexed in the frequency and/or the time domain.

The preferred embodiment of the apparatus of the invention makes use of at least one radio connection as wireless communications means. This may involve a transmitter, a receiver, or advantageously a transceiver operating in full or half duplex. It is preferred to use a both-way digital connection at high speed, and if possible complying with a widespread industrial standard. The invention seeks more particularly to provide services that require at least one high performance wireless connection to be implemented, so that, where possible, use is advantageously made of diversity techniques in reception and/or transmission, e.g. making use of a WiFi variant such as 802.11n.

Nevertheless, without going beyond the ambit of the invention, it is possible to implement a one-way analog solution, e.g. for the purpose of transmitting a video signal together with sound to at least one other television set within the same premises. Adding receiver means arranged to receive remote control signals relayed by radio waves is particularly advantageous. This makes it possible to transmit commands to the apparatus of the invention, which can then interpret them or forward them locally to the portable device. The apparatus of the invention or the portable device acting via the apparatus can, where appropriate, send commands to other devices. All of these direct or induced commands are the result of actions taken on an infrared remote control situated in a room other than that containing the apparatus of the invention. The adapter that receives signals coming from the apparatus for playing them to another TV set for example, includes, or is advantageously attached to, an infrared remote control receiver having an output that directly or indirectly controls a radio transmitter for sending information to the apparatus, through partitions of the building.

Naturally, it would not go beyond the ambit of the invention if the at least one wireless communications interface were to rely on modulating an infrared signal.

The at least one function can be putting at least one electrical circuit of the portable electronic device directly or indirectly into continuity with an electrical circuit of at least one other electronic device. The minimum function of the apparatus of the invention is making a connection between input/output signals of the portable electronic device with the inputs/outputs of at least one other electronic device. This connection may be direct, making use of no more than wired or printed cabling and connectors. This basic function provides the advantage of enabling a plurality of connectors to he connected and disconnected substantially in a single movement, generally involving numerous cables for which, in addition, the quality of the connectors fitted thereto is not designed for use in a large number of connection/disconnection cycles. Establishing such a connection can also involve active circuits within the apparatus. These may be buffer amplifiers, impedance adapters, level adapters, digital-to-analog and analog to-digital converters, protocol and interface adapters.

At least one function can be establishing direct or indirect continuity between at least one electrical circuit of the portable electronic device and at least one wireless communications interface. The wireless communications interface of the apparatus can be used to enable the portable device to benefit directly therefrom. This may involve providing a wireless interface to a portable device that does not have one, e.g. in order to enable it to connect to a local and/or remote wireless network, e.g. a WiFi network. This may likewise involve providing connectivity using a wireless communications standard other than that incorporated in the portable device, e.g. a different WiFi variant. This may also involve receiving a video and/or audio stream coming for example from an external local server, a computer, a digital recorder, etc.

The at least one function may be establishing direct or indirect continuity between at least one electrical circuit of at least one other electronic device and at least one wireless communications interface. This involves making resources of the apparatus of the invention in terms of wireless communication available to at least one other device. This can be done by electrical circuit continuity and/or by implementing adapter circuits possibly involving active circuits for converting levels, interfaces, protocols, or applications for providing the functions expected from the resources available.

The at least one function may be establishing direct or indirect continuity between at least one input and an output of substantially the same nature under determined conditions. This may involve, for example, providing a “pass through” function, e.g. to enable signal inputs to be directed to outputs of substantially the same nature and/or enabling signal outputs to be directed towards inputs of the same nature under determined conditions. By way of example, these conditions may be associated with the presence or the absence of the portable device. Or they may be associated with an active or inactive connection, when it is possible to have a wireless connection between the portable device and the apparatus of the invention. Regardless of whether the connection/disconnection is physical or logical, via interposed wireless communications means, between the portable device and the apparatus/redirecting all or some of the inputs/outputs may be associated with selecting particular playback or recording functions.

The terms “inputs” and/or “outputs” of substantially the same nature designates inputs and/or outputs that are functionally equivalent, but that comply with different standards, possibly involving connectors, electrical characteristics, and/or communications protocols, and/or encryption means, where appropriate. As non-limiting examples, mention can be made of: composite video input and/or output, S-VHS, with so-called “separate” components, DVI for the image. Or indeed analog line input and/or output, S/PDIF for sound, SCART/peritel or HDMI for image and sound combined.

The at least one function may be an access point in a wireless communications network. This involves causing the apparatus to act as an access point in a network connected to local or remote resources. For example, this may involve a WiFi access point or an access point to any other wireless local network standard.

The at least one function may be gateway between said wireless communications network and a local network using wired means. The gateway function provides local network continuity by changing physical medium and where appropriate performs certain adaptations in all or some of the communications protocols, such as for example addressing plans or acknowledgment and/or reception conditions. This may also involve a gateway function between a wireless local network, e.g. a WiFi network and a simple wired point-to-point connection between the apparatus of the invention, e.g. in compliance with the Ethernet standard, and any other local resource fitted with a compatible interface, such as a computer.

The at least one function may be a gateway between said wireless communications network and an infrastructure network making use of wired means. This involves a variant of the gateway function providing functional continuity between a wireless local network, e.g. a WiFi network, and an infrastructure network, e.g. via an ADSL access, via an optical fiber, or via a cable to the Internet. The connection between the wireless local network, e.g. using the 802.11g standard with an access point situated in the apparatus of the invention and the access interface to an infrastructure network based on wired means can be provided by other wired means, such as for example a point-to-point Ethernet connection or via a concentrator and/or a router or some other connection using wireless means, e.g. a compatible standard having a data rate that is greater than or equal to that used in the apparatus, e.g. using the 802.11n standard.

The at least one function may be a gateway between said wireless communications network and an infrastructure network using other wireless means. This variant relates to making a connection to an infrastructure network that itself makes use of other wireless means, e.g. WiMax, iBurst, HSDPA. The wireless interface with the infrastructure network may be offset by wire means or advantageously it may be incorporated in the apparatus of the invention. The apparatus then becomes the point of entry to the infrastructure network and the means for accessing services associated with that network for any other connected electronic devices that are involved and/or for the portable electronic device(s) associated with the apparatus.

The at least one function may be a repeater for extending the range of another wireless communications network. This gateway functional variant seeks to extend the range of a local wireless network and/or to improve its quality of service. For example, it is possible to make use of a plurality of channels that are generally associated with a wireless communications standard in order to retransmit on one or more other channels the information received on one or more others. Thus, information coming from a remote transmitter and received at the sensitivity limit of the local receiver can be retransmitted at nominal power so as to extend the broadcast zone. In addition, the quality of service associated with a wireless connection is related at least in part to the power of the received signal. A high level of quality of service is essential for applications that consume a large amount of bandwidth on a practically continuous basis throughout the use of a service such as telephony, video telephony, streaming audio content, or indeed streaming video content. This function can contribute effectively to obtaining a high level of quality.

The at least one function may be converting a first data stream received from an external content source into at least one second data stream intended specifically for a portable electronic device previously associated with the apparatus of the invention. The conversion function is particularly advantageous in non-uniform systems in which information may come from and/or be destined for different systems. The differences may relate, for example, to encoding standards, to the transport layer when conveying streams, to acknowledgment and/or repeat mechanisms, etc. For example, in order to offer a high quality video content streaming service, it is most advantageous to make use of broadcasting in so-called “unicast” mode if the passband of the transmission system makes that possible. When broadcasting in this mode, the transmitter transmits the data stream to a single destination of address previously recorded in the transmitter, e.g. during a prior so-called “association” stage. The receiver may also know the address of the transmitter in the network in order, where appropriate, to be able to send requests for data blocks to be repeated exclusively to the corresponding transmitter. Historically, transmission in “unicast” mode was replaced by transmission in “multicast” mode in many digital video stream transmission applications for reasons of efficiency in a context of bandwidth scarcity. The problem with transmission in “multicast” mode is the absence of mechanisms for retransmitting erroneous data, which can lead very quickly to a drop in the perceived quality. With the arrival of new wireless communications standards providing much higher data rates, it is again becoming possible to use unicast mode digital streaming transmission under good operating conditions. Depending on the resources available, it is possible to manage substantially simultaneously a plurality of streams in a “multi-unicast” mode. Most TV on IP services and/or most video on demand (VOD) services that are distributed in streaming mode, deliver their contents in multicast mode for reasons of ease of management and of infrastructure dimensioning. In addition, since infrastructure networks are based mainly on wired means, delivery to the point of consumption in multicast mode does not raise problems of quality. In contrast, the conversion by internal broadcast means on the site of consumption to wireless means for reasons of ease of installation can lead to sources of poor quality. The apparatus of the invention advantageously incorporates a multicast to unicast mode conversion function in the context of an implementation seeking to deliver high quality service. Broadcasting in “unicast” or “multi-unicast” mode in the wireless local network also presents the advantage of providing a first level of content confidentiality since in principle the contents can be received only by devices that have previously been associated. Solutions based for example on the VLC client can be implemented in the portable devices to make use of the streams broadcast by the apparatus. Naturally, it would not go beyond the ambit of the invention for the conversion functions, where appropriate, to relate to other characteristics such as different transport or encoding formats. This can apply in particular to completely or partially decrypting incoming streams within the apparatus of the invention so as to rebroadcast them in the clear or encrypted using some other standard by the wireless means on the site of consumption.

The at least one function may be broadcasting a data stream representing a TV and/or video and/or audio content via at least one wireless communications interface to at least one portable electronic item. This function enables the apparatus to use its incorporated wireless means for transmitting to one or more portable electronic devices that have advantageously been previously associated with the apparatus in the context of “unicast” or “multi-unicast” broadcasting. A particularly advantageous functional refinement consists in detecting disconnection and reconnection of the portable device relative to the apparatus of the invention via their common interface 3, e.g. by detecting a change in the state of the circuits for transferring energy or by detecting the state of continuity in transmitting a signal between the two devices.

The at least one function may be broadcasting a data stream representing a TV and/or video and/or audio content via the at least one wireless communications interface to at least one external playback means. This function enables the apparatus to transmit an audio and/or video stream or signal to one or more other playback means such as another TV set, video projector, home cinema amplifier, hi-fi system, loudspeaker system, etc. Advantageously, these means for broadcasting an audio and/or video source as implemented in the apparatus of the invention can be associated with internal or external source switching functions for providing multiple combinations for connections between sources and playback means. It is particularly advantageous to associate this function with remote control means for at least some of the functions implemented directly or indirectly in the apparatus. Naturally, the broadcast function may rely on and/or coincide with one or more conversion functions as described above.

The at least one function may be a function of digitally recording an audio and/or video stream in mass storage means also incorporated in the apparatus, together with encoder means and, where appropriate, converter means for recording an analog stream, and/or means for selecting the origin of the stream to be recorded. This involves implementing a digital recording function in the apparatus. The apparatus of the invention is potentially in a situation to receive a plurality of analog signals and/or digital streams representing audio and/or video contents. It is particularly advantageous to be able to record contents within the apparatus itself. Means for selecting the source for recording and/or for programming deferred recording are advantageously incorporated in this function. Naturally, with analog signals, appropriate converters and encoders are needed.

By way of example, the mass storage means may be a hard disk and/or solid state memories such as flash memories, FeRAM, EEPROM, or memories based on other technologies in the future.

The at least one function may be a function of playing back an audio and/or video digital content residing in mass storage means also incorporated in the apparatus together with decoder means, and where appropriate converter means for playing back an analog stream and/or means for selecting the destination of the stream to be played back. This involves the function that is the converse of the recording function with which it is advantageously associated. Nevertheless, this function can be useful even if the stream recording function is not implemented in the apparatus it is possible to transfer video and/or audio content files, e.g. for the purpose of playing them back via one or more other devices connected to the apparatus of the invention such as a TV set, a video projector, a home cinema amplifier, a hi-fi system, etc. The transfer of at least one content file into the mass memory incorporated in the apparatus can advantageously be performed by any data transfer means implemented in the apparatus, e.g. via a so-called “device”; USB port, via a so-called “host” USB port, via a so-called “OTG” USB port, via a Firewire (IEEE1394) port, via an Ethernet connection, via infrared or wireless means such as IrDA or WiFi, via a direct or indirect connection to an infrastructure network via an ADSL wire, cable, or optical fiber or wireless connection such as WiMax or HSDPA, or indeed by any other means such as future successors to these standards.

Additional means for decrypting and/or managing rights associated with the works transferred may be added, in particular in the context of an application to selling or renting video or music on demand. Associated means such as an internal or external smart card reader for decrypting and/or payment purpose may also advantageously be incorporated in the apparatus of the invention.

It may be advantageous to use at least one non-volatile memory card reader as means for implementing a function of playing back and/or saving digital content that makes use of this type of medium. The drop in the sales price and the increase in the capacity of such flash memory cards, particularly when they provide incorporated mechanisms for protecting content, e.g. SDMI as implemented in the “SD card” standard, make them media that are suitable for broadcasting musical and/or video and/or photo and/or text works.

Similarly, a reader subassembly, or indeed a reader/recorder subassembly using an optical medium such as DVD, HD-DVD, Blue Ray can be used as means for implementing a playback and/or saving function for digital content within the apparatus of the invention.

The at least one function may be a function performing synchronization between the portable electronic device and the apparatus of the invention, relating to all or some of the digital contents stored in the mass storage means also incorporated in the apparatus and/or those incorporated in the portable electronic device. The term “synchronization” is used to mean automatically updating the contents stored in one and/or the other of the mass storage means. Synchronization can take place in one direction only and/or both directions, globally or in compliance with attributes associated with the stored digital objects. Synchronization may also be selective, depending on criteria that may optionally be set by the user, such as whether a particular digital object has or has not already been played back, as a function of the date on which the file was created in the local mass memory, etc.

Synchronization also includes, where appropriate, transferring rights associated with the works. These rights may be the subject of an automatic transaction seeking to recalculate all or some of the encryption keys and to transfer them to the target device when the rights are associated in one-to-one manner with a given machine, that being the only machine entitled to play back the works.

The at least one function may be a server function for audio and/or video and/or image digital contents. This variant embodiment of the apparatus includes an audio and/or video server function suitable for making a selection available to the user and for delivering audio and/or video contents to the user. The server function is advantageously arranged to be capable of making available and delivering contents on playback means that are connectable directly to the apparatus in point-to-point mode by wired or wireless means. Still more advantageously, the playback means should be connectable to a local network that includes the apparatus of the invention and/or that is remote therefrom using playback means connected to an infrastructure network to which the apparatus of the invention is also connected, either directly or indirectly. In certain variant embodiments, the playback means may for example comprise one or more portable multimedia players, one or more TV sets, video projectors, home cinema amplifiers, hi-fi systems, loudspeaker systems, etc. Where necessary, these devices may require an adaptation interface. The term “infrastructure network” is used to mean networks giving access to the Internet, possibly via any wired or wireless physical medium or indeed wireless type telephone network infrastructures of the so-called third, fourth, et seq. generations. One use of the apparatus that is particularly spectacular consists in consulting, selecting, and playing back digital contents remotely from a home server, possibly included in the apparatus of the invention, in streaming mode on a portable multimedia player fitted with means for establishing a wireless connection to the Internet, e.g. by WiFi. This use can be envisaged in a mobile situation, in which case it suffices to be in a so-called “hot spot” zone. This implementation of the invention can also be envisaged in a hotel where rooms can be prefitted with apparatus of the invention connected firstly to the TV set and secondly to a network access. A client having a terminal that is compatible with the invention of the invention can then access that client's own usual personal environment, music library, video library, and photo library.

Conversely, the invention makes it possible to transfer digital contents from a remote source into the means of the apparatus of the invention that implements the digital content collection function. An example of a remote source may be another portable multimedia player/recorder optionally incorporating a video or still camera function. This can also apply for example to a video camera or to a digital camera having as original equipment or as an accessory the option of establishing a wireless connection, such as a WiFi connection. Such devices generally also incorporate a capacity for local storage that is used as a buffer memory so as to enable images to be acquired in a disconnected mode and subsequently transferred into the storage means of the apparatus of the invention, e.g. once a network connection is possible and/or once the buffer memory is saturated and/or on command from the user.

A system for broadcasting digital contents or television programs within a premises or a transport means may comprise:
apparatus as described above arranged to broadcast a digital stream via a wireless communications interface; and
a portable electronic device arranged to:
   receive the digital information stream broadcast by the apparatus;
   decode the received information and where appropriate decrypt it;
   play back the image and/or the sound of the digital content or TV program received by means incorporated in or connected to the portable electronic device.

For example, in home or professional premises, or indeed in transport means, this involves broadcasting digital contents or television programs in streaming mode from the wireless communications interface of the apparatus of the invention. In this variant embodiment, the destination equipment comprises one or more portable electronic devices.

Said contents or programs may come from sources internal to the apparatus, e.g. if it incorporates a function of reading a fixed and/or removable mass memory and/or a memory on an optical medium. Said contents may come from other devices suitable for being connected to the apparatus via appropriate standard interfaces. When these sources are analog sources, appropriate analog-to-digital conversion and encoding in the form of a digital stream suitable for broadcasting by the wireless means of the apparatus form part of at least one function of the apparatus of the invention. Advantageously, a return path from the wireless communications system enables the portable electronic device to control at least certain functions of the apparatus of the invention. These functions include in particular selecting a particular digital content or streaming source, and commands enabling broadcasting to be stopped and started, for example. It is possible to add thereto, by way of example, conventional functions of an audio and/or video player such as fast forward and/or East reverse, and possibly at several different speeds, e.g. ×2, ×4, ×16. The user interface of the portable electronic device may include a keypad and/or a touch-sensitive screen, and is normally used independently for controlling the playing back of contents stored in the memory of the device. Advantageously, the same user interface is reassigned to the means used for playing back a digital stream received in streaming mode. This reassignment requires commands to be sent to the broadcasting device via a return path that is advantageously included in the wireless communications interface on which broadcasting relies, although it is possible to make use of a return path making use of means that are distinct.

In the advantageous implementation of broadcasting in “unicast” mode, an association is initially established between the communicating portable device and the apparatus of the invention so as to enable each of them to inform the other of its own address. Means are implemented in the portable device in the form, for example, of a command in an installation menu for participating in the procedure for association with the apparatus.

In another aspect of the invention, there is provided a system for broadcasting digital contents or TV programs within a premises or transport means, the system comprising:
apparatus as described above, the apparatus being arranged to broadcast a digital stream via a wireless communication interface;
at least one other electronic device connectable via at least one standard interface for playing back a video image and/or the associated sound;
a receiver interface connected to the at least one other standard electronic device for playing back a video image and the associated sound, the receiver interface being arranged:
   to receive the digital information stream broadcast by the apparatus;
   to decode the received information, and where appropriate decrypt it; and
   to play back the image and the sound of the digital content or television program received via the at least one other standard electronic device connected thereto for playing back a video image and/or the associated sound.

This is a variant implementation in which digital contents or TV programs are received by means of a receiver interface connected to the at least one other standard electronic device for playing back a video image and the associated sound.

In a particularly advantageous embodiment, the same apparatus of the invention can be used equally well as a broadcasting point and as a reception interface. Using the same type of device both for broadcasting and for receiving content provides numerous advantages both for the manufacturer and for users. The manufacturer limits the number of products that need to be designed, manufactured, and sold in order to satisfy most customer requirements, in particular in terms of functions and types of interface for connection to other electronic devices. The user has the advantage of being able to put down and/or recharge portable electronic devices at several locations in the premises, needs to know only one operating technique, and has the potential of sharing contents of origins and/or destinations that are not imposed by choices made during installation that set once and for always the locations where the broadcaster and the receiver point(s) are to be found. The device of the invention in its preferred embodiment has the resources necessary for operating both in broadcasting and in reception. By way of example, these resources are wireless transmission and reception means for transmitting content, encoding and decoding means, input and output conversion means, input and output switching means, means for receiving an infrared remote control signal, and means for interpreting and/or relaying infrared signals to said other electronic devices. A prior stage of associating devices of the invention so as to enable them to exchange content serves to define a wireless local network for sharing digital contents. This operation can rely on an association pushbutton arranged so as to avoid accidental presses. Association can also rely on taking action on a remote control and optionally involves a screen.

By way of example, this may involve making use of the contents on one or more playback means such as a TV set, a video projector, a hi-fi system, or a home cinema unit, that are remote from the apparatus broadcasting the content over its wireless means within the premises. The reception interface advantageously incorporates an infrared remote control receiver and has access to a return path in the wireless transmission system so as to enable the user to control at least some of the functions of the apparatus of the invention, as in the above-described example.

It is also possible to provide a system for broadcasting digital contents or television programs within a premises or a transport means as described above and further including a direct or indirect connection to a high speed infrastructure network in order to acquire therefrom television program and/or video content and/or musical content streams.

The streams may come from a remote database via a direct or indirect high speed connection to the Internet. The term “direct connection” is used to mean a connection involving means for connection to an infrastructure network that are incorporated in the apparatus of the invention, such as for example an ADSL modem for a telephone pair, a coaxial cable modem or an optical fiber modem, or integrating an interface with a high speed wireless infrastructure network. The term “indirect connection” is used to mean connecting the apparatus to the infrastructure network via a device external to the invention such as a modem or a modem router to which the apparatus is connected via a point-to-point connection, e.g. an Ethernet or a USB connection, or via a local network.

Other advantages and characteristics of the invention appear on examining the detailed description of a non-limiting embodiment and the accompanying drawings, in which:

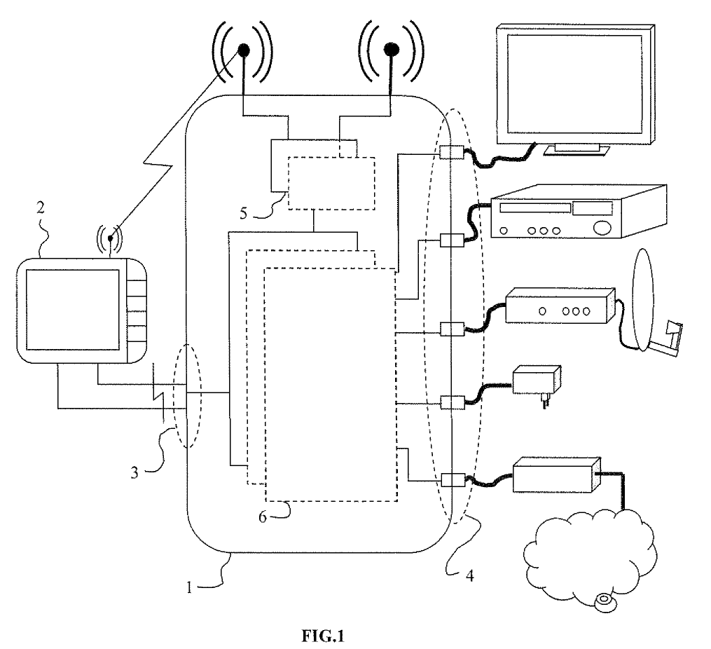

FIG. 1 shows an apparatus of the invention in a representative environment involving a portable electronic device 2 and other electronic devices;

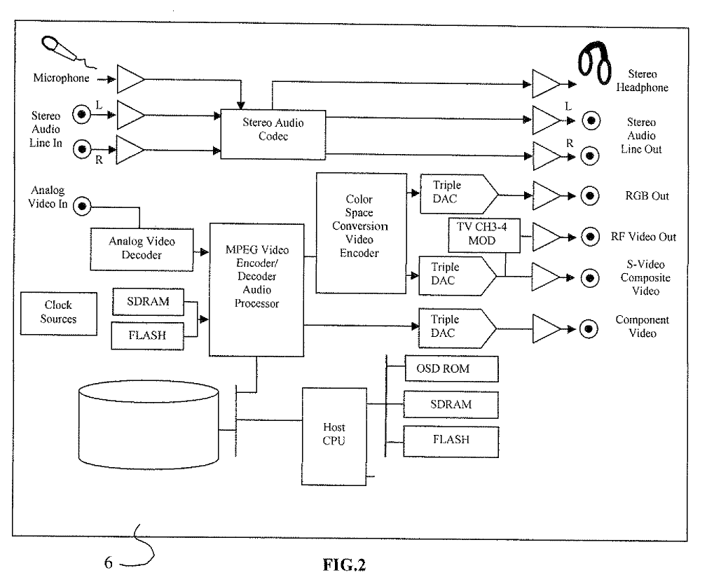

FIG. 2 shows the means implemented for the digital multimedia player/recorder function;

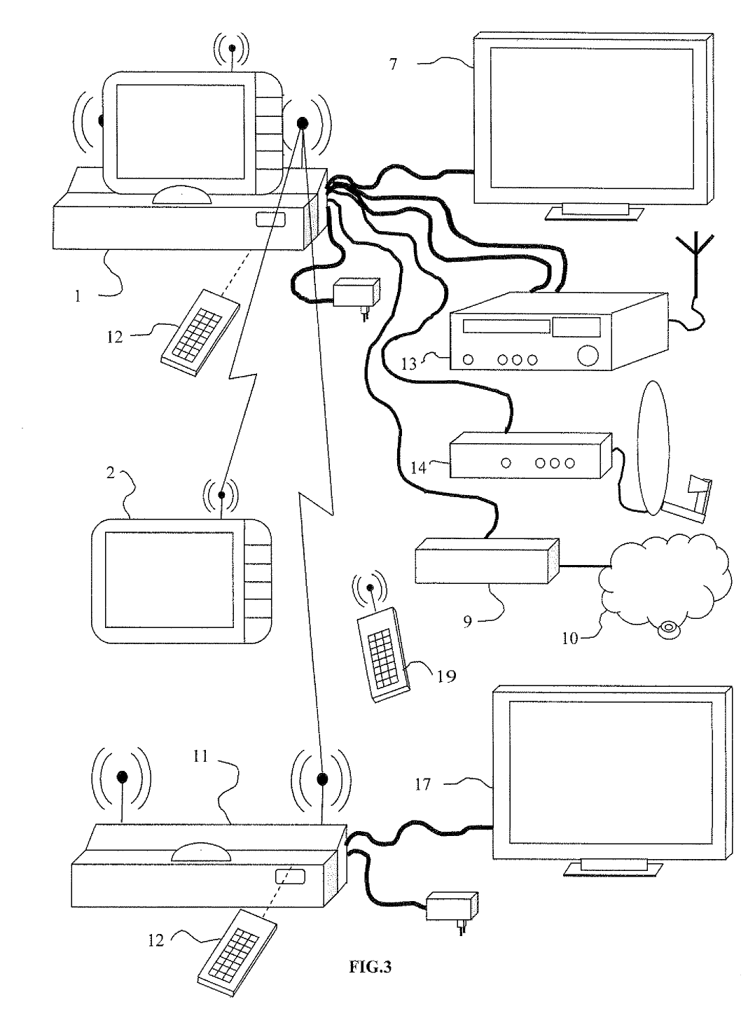

FIG. 3 shows a first variant of the system of the invention in an environment representative of its use;

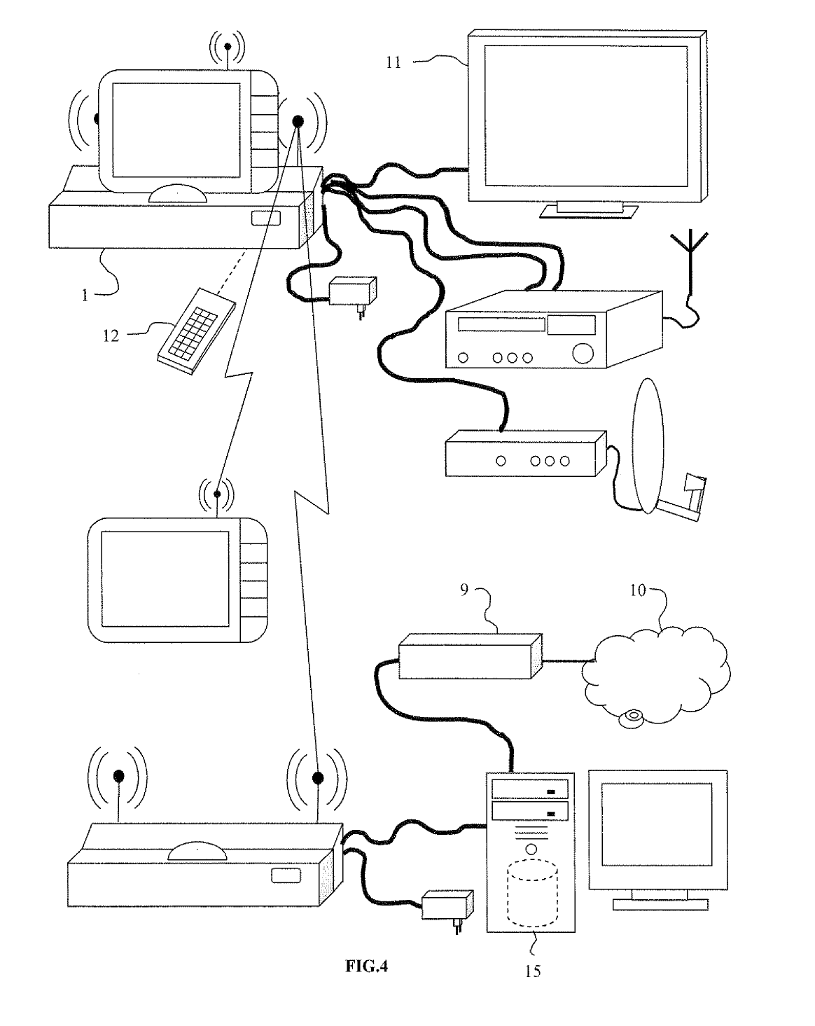

FIG. 4 shows a second variant of the system of the invention in an environment representative of its use;

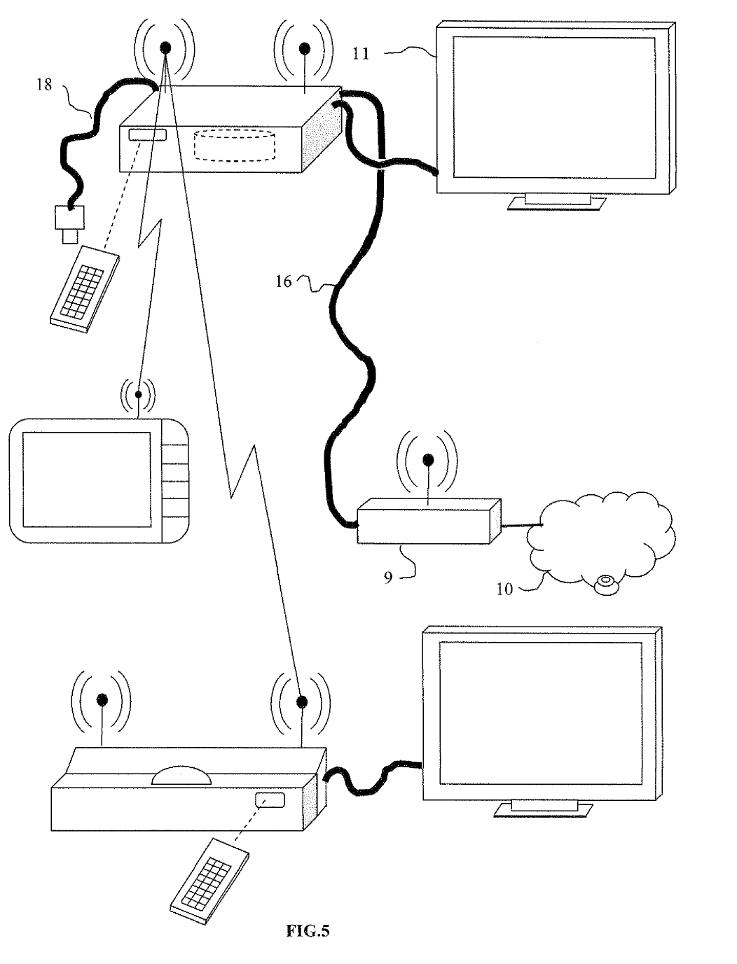

FIG. 5 shows a third variant of the system of the invention in an environment representative of its use; and

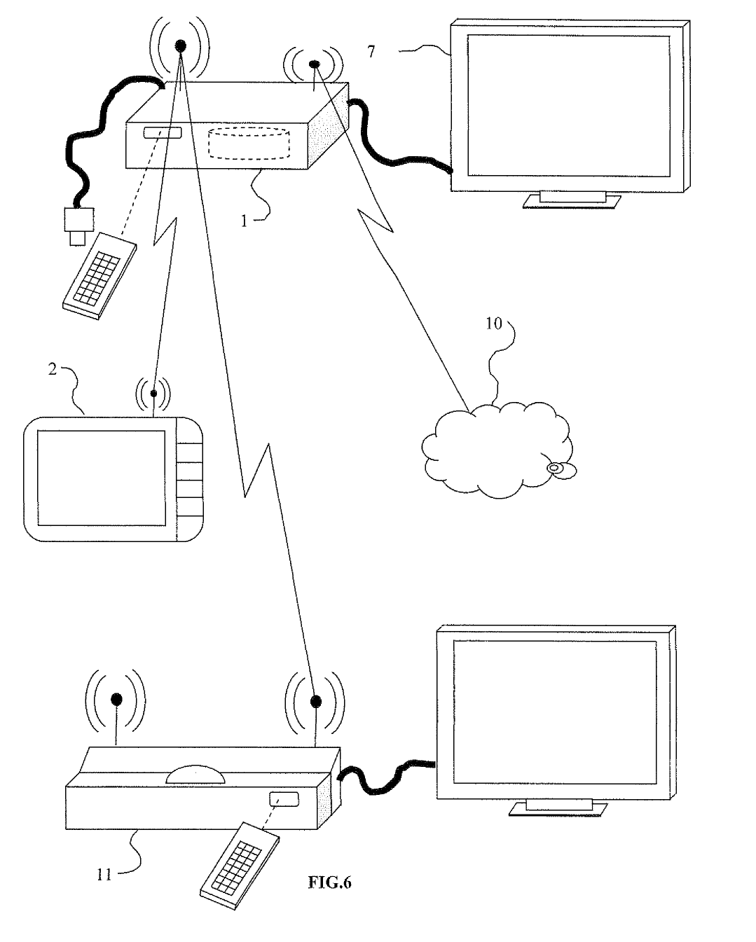

FIG. 6 shows a fourth variant of the system of the invention in an environment representative of its use.

### DETAILED DESCRIPTION OF THE FIGURES

FIG. 1 shows the apparatus of the invention 1 for connecting a portable electronic device 2 to other electronic devices. The apparatus 1 comprises means for transferring energy to the portable electronic device and means for establishing continuity of at least one signal between the portable electronic device and the apparatus. In this figure, these means are combined in a common interface 3. It should be observed that the interface 3 could be embodied by using a standard digital input/output (I/O) port that provides the capacity for the apparatus to transfer energy to the portable device together with transmission capacities at a data rate that is sufficient for transporting a video stream, for example. A suitable connection would be via a USB2 port or a 6-wire Firewire (IEEE1394) port, for example. The port of the “host” type is associated with the apparatus of the invention and the corresponding port of the “device” type is associated with the portable device.

The apparatus further comprises at least one interface 4 for establishing continuity of at least one signal with at least one other electronic device. The apparatus has at least one wireless communications interface 5 represented in this non-limiting example by a radio transmission subassembly making use of antenna diversity. All of the means for establishing continuity of a signal with the portable electronic device and the at least one other electronic device are separable at at least one end. These separable means may be relatively rigid and secured at least in part to the walls of the devices concerned, as represented by the interface 4. These means may also make use of flexible solutions, e.g. using one or more cables fitted with one or more connectors at one or both ends. The interface 4 shows the interface of the apparatus of the invention with external devices. For this interface, more or less rigid connection solutions can be envisaged. The preferred implementation relies on cables fitted with suitable standard connectors connected releasably to receptacles secured to the wall of the apparatus. Generally, these cables can also be separated from the interface with said other electronic devices, except concerning the mains power supply.

FIG. 2 shows another non-limiting example of means 6 implemented in the apparatus of the invention for embodying a function of recording and reproducing multimedia contents stored in digital form and including the encoders and decoders for acquiring and playing back analog signals.

With reference to FIG. 3 showing a non-limiting example of use, an apparatus of the invention is installed in the sitting room of a dwelling. The apparatus 1 is advantageously connected to all the potential sources of video and/or musical contents and to means 7, 13 for playing back these contents. Any content source can be connected, such as, for example, a CD and/or DVD and/or HD-DVD and/or Blue Ray player, a demodulator/receiver 14 for programs broadcast by satellite, a DVB-T and/or DVB-H and/or DVB-S receiver, an analog FM radio tuner 13, a digital radio tuner, e.g. DAB with enriched services such as DMB or DAB/IP. A connection with a broadband infrastructure network 10, e.g. by means of an ADSL modem 9 is also provided for accessing digital content via a generic Internet browser or via dedicated applications interfaces directly accessing their own servers as soon as they are connected to the network. This figure shows that the apparatus 1 is also capable of broadcasting digital streams representing a TV station, video that has been purchased or rented on request using a physical medium or an on-line service accessible via the connection to an infrastructure network. This can also apply to video or music recorded by the user by means incorporated in a portable multimedia player/recorder 2 connected to the apparatus 1, or indeed by means incorporated in the apparatus 1 of the invention for implementing a digital recording function. Amongst the digital information broadcast by the apparatus of the invention to devices capable of making use thereof, possibly after an initial association stage, there is information inviting the user to make a choice. The choice may involve the source of the broadcast digital stream, when the source proposes a plurality of programs such as, for example, a source of television or radio programs, with these choices advantageously being made available to the user. The television and/or radio programs for selection can advantageously be made available in the form of program schedules for facilitating browsing and choosing within the space of available choices. In addition to conventional regional and national stations, it is possible to make available a worldwide offer of contents that are accessible via the connection to the infrastructure network. Some of the choices may be conditional, for example they may be subjected to a monetary transaction, on a one-off basis or on a subscription basis, with a holder of rights or with a content supplier. The user can make a choice by means of a remote control 12 optionally in association with a proposal displayed on a screen. When the broadcast content is received and run on a portable multimedia device, the “normal” user interface of the device can be used to display available choices and to select amongst them, and also to select commands associated with running the content. This figure also shows that in addition to broadcasts, from the apparatus 1 to one or more portable electronic devices 2 within the premises or the transport means, the system of the invention is also designed to broadcast digital content to other playback devices 17 that are fixed. These devices fitted with standard digital and/or analog interfaces play back the image and the sound they receive and decode by means of an adapter that is compatible with the means used for broadcasting. In particularly advantageous manner, the adapter for receiving and decoding the stream is another apparatus 11 of the invention configured to operate as a receiver. It is also possible to specialize apparatuses of the invention so that each apparatus is dedicated to broadcasting or to receiving, while maintaining subassemblies in common such as a housings and interfaces. Under such circumstances, this specialization is embodied by selecting different means for implementing at least one function. It is particularly advantageous for the user to have a plurality of apparatuses offering an interface 3 in different locations. These apparatuses constitute as many places where a portable device that can be used on a mobile basis in the premises can be placed on an appropriate support and capable of maintaining a state of charge that is always ready for use in the energy storage means of the portable devices.

Naturally, it remains within the ambit of the invention for content-playback devices to incorporate by construction means for receiving and decoding the broadcast streams. For example, this may involve a WiFi TV/IP tuner. The system is made much more comfortable by using local remote controls close to the place where playback is taking place, and making use of infrared signals for communicating directly with the broadcast apparatus 1 or indirectly via receiver adapters that translate and relay infrared commands they receive over a return channel of the wireless communications interface towards the broadcast apparatus.

It is also possible to use specialized radio remote controls 19 capable of communicating directly with the broadcast apparatus through some number of walls and ceilings. It should be observed that it would not go beyond the ambit of the invention for the system to be used to broadcast not a data stream for use in a streaming configuration, but a data stream representing a transfer of content from one place of storage to another. It is also possible to perform both types of multimedia data stream operations substantially simultaneously by viewing in progressive loading mode. This mode is possible in satisfactory manner, i.e. without service interruptions being observable, on the condition that the loading data rate is greater than the data rate needed for reading contents.

FIG. 4 shows a system of the invention in a context representative of its use. In this non-limiting example of use, an apparatus of the invention is installed in the sitting room of a dwelling as in the example shown in the preceding figure. This example shows the advantage of using portable apparatuses of the invention including functions that make it possible to operate as a broadcaster of content streams or as an adapter/receiver/decoder, depending on requirements. Advantageously, the apparatus can operate as a broadcaster and as a receiver/decoder simultaneously, at least for certain sources for which the data format incorporates elements of a transport layer or requires only limited processing, and means for enabling broadcasting or reception to be performed. Tn this example, an apparatus 1 of the invention serves to broadcast content stored in the memory of a computer 15 or arriving in the form of a first stream via an access of the infrastructure network providing a connection to the Internet. The content is broadcast in the premises by the apparatus 1 and it is received by a second apparatus of the invention, which for example plays back the image and the sound of the content on a remote TV set. The apparatus is also capable, when necessary, of broadcasting to the portable terminal 2 some other content coming from another source, or indeed of rebroadcasting the same content. Rebroadcasting the same content in a “multicast” mode can be performed by using a repeater function.

FIG. 5 shows in nonlimiting manner a system in which the apparatus of the invention is in the form of an indoor digital player/recorder. In this example, the interface 3 providing signal continuity with, and energy transfer to, a portable electronic device is a cable 18 providing a connection between USB ports. A connection between the apparatus of the invention and an infrastructure network is provided by means of an ADSL modem. This connection can be embodied by a wire connection 16, e.g. an Ethernet or USB connection, or indeed the connection may be implemented by wireless transmission means if the modem is fitted with a wireless communications interface providing a data rate that is sufficient for transmission video streams, or indeed high definition video streams.

FIG. 6 shows a system of the invention that differs from the preceding system in that the apparatus of the invention implements a gateway function between a broadband wireless infrastructure network 10, e.g. WiMax, and a wireless local network such as a fast and high quality variant of WiFi, e.g. 802.11n. The apparatus of the invention can thus, on its own, access services that require access to the Internet. The apparatus of the invention in this variant can advantageously be deployed by service or network operators or indeed by Internet access providers in the context of added-value broadband offers.

Naturally, the means implemented in the invention, in particular when an Internet connection is effective, can also be used in the context of standard applications of the WWW browser type, on-line shopping, email, etc.

Naturally, the invention is not limited to the embodiments described above and numerous modifications can be applied thereto, with it being possible for other combinations of characteristics and/or implementations to be selected without going beyond the ambit of the invention. In addition, the examples of technical standards or solutions that are mentioned are those that are applicable at the time the patent application is filed. They could well disappear or be replaced quickly by others, without thereby making the invention itself obsolete.

1-31. (canceled)

32. Apparatus for connecting a portable electronic device that is capable of storing digital content in a memory and of playing and/or recording video, to at least one other electronic device, the apparatus comprising:
an interface for establishing continuity of at least one signal between said apparatus and the portable electronic device and/or for transferring energy to the portable electronic device; and
at least one interface for establishing continuity of at least one signal between said apparatus and the at least one other electronic device; and
at least one wireless communications interface; and
means for implementing at least one function involving all or some of the resources implemented in said apparatus.

33. Apparatus according to claim 32, including an interface for transferring energy to said portable electronic device, said interface implementing the continuity of at least one electrical circuit via separable means.

34. Apparatus according to claim 32, including an interface for transferring energy to said portable electronic device by inductive coupling.

35. Apparatus according to claim 32, including an interface for establishing continuity of at least one signal between said apparatus and the portable electronic device relying on the continuity of at least one electrical circuit via separable means.

36. Apparatus according to claim 32, including an interface for establishing continuity of at least one signal between said apparatus and the portable electronic device, making use of the continuity of at least one optical circuit via separable means.

37. Apparatus according to claim 32, including an interface for establishing continuity of at least one signal between said apparatus and the portable electronic device by inductive coupling.

38. Apparatus according to claim 37, in which the interface for establishing continuity of at least one signal between said apparatus and the portable electronic device uses the same inductors as for transferring energy.

39. Apparatus according to claim 32, including an interface for establishing continuity of at least one signal between said apparatus and the portable electronic device, implementing captive coupling.

40. Apparatus according to claim 32, including an interface for establishing continuity of at least one signal between said apparatus and the portable electronic device, implementing a micropower radio connection.

41. Apparatus according to claim 32, including an interface for establishing continuity of at least one signal between said apparatus and the at least one other electronic device, said interface relying on the continuity of at least one electrical circuit via the separable means.

42. Apparatus according to claim 32, including an interface for establishing continuity of at least one signal between the apparatus and the at least one other electronic device, said interface relying on the continuity of at least one optical connection in guided mode via at least one optical circuit connected via the separable means and/or in radiated mode.

43. Apparatus according to claim 35, in which the separable means are attached in full or in part in substantially rigid manner to a wall of the apparatus.

44. Apparatus according to claim 35, in which the separable means are attached in full or in part via flexible means, possibly detachable means, to the apparatus.

45. Apparatus according to claim 32, wherein at least one function comprises establishing direct or indirect continuity for at least one electrical circuit of the portable electronic device with an electrical circuit of at least one other electronic device.

46. Apparatus according to claim 32, wherein the at least one function comprises establishing direct or indirect continuity of at least one electrical circuit of the portable electronic device with the at least one wireless communications interface.

47. Apparatus according to claim 32, wherein the at least one function comprises establishing direct or indirect continuity of at least one electrical circuit of the at least one other electronic device with the at least one wireless communications interface.

48. Apparatus according to claim 32, wherein the at least one function comprises establishing direct or indirect continuity of at least one inlet with an outlet of substantially the same nature in determined conditions.

49. Apparatus according to claim 32, wherein the at least one function comprises a point of access in a wireless communications network.

50. Apparatus according to claim 32, wherein the at least one function comprises a gateway between said wireless communications network and a local network making use of wired means.

51. Apparatus according to claim 32, wherein the at least one function comprises a gateway between said wireless communications network and an infrastructure network making use of wired means.

52. Apparatus according to claim 32, wherein the at least one function comprises a gateway between said wireless communications network and an infrastructure network using other wireless means.

53. Apparatus according to claim 32, wherein the at least one function comprises a repeater for extending the range of another wireless communications network.

54. Apparatus according to claim 32, wherein the at least one function comprises converting a first received data stream coming from an external content source into at least a second data stream specifically for a portable electronic device previously associated with the apparatus of the invention.

55. Apparatus according to claim 32, wherein at least one function comprises broadcasting a data stream representing a TV and/or video and/or audio content via the least one wireless communication interface to at least one portable electronic product.

56. Apparatus according to claim 32, wherein the at lest one function comprises a function of playing an audio and/or video digital content residing in mass storage means also included in the apparatus, together with decoder means and, where appropriate, converter means for playing back an analog stream and/or means for selecting the destination of the stream for playing back.

57. Apparatus according to claim 32, wherein the at least one function comprises a synchronization function between the portable electronic device and the apparatus of the invention bearing on all or some of the digital contents stored in the mass storage means also included in the apparatus and/or those included in the portable electronic device.

58. Apparatus according to claim 32, wherein the at least one function comprises a server function for audio and/or video and/or photo digital contents.

59. Apparatus according to claim 32, wherein the at least one function comprises a function of collecting audio and/or video and/or photo digital contents.

60. A system for broadcasting digital contents or television programs within a premises or a transport means, the system comprising:
apparatus according to claim 32 arranged to broadcast a digital stream via a wireless communications interface; and
a portable electronic device arranged to:
receive the digital information stream broadcast by the apparatus;
decode the received information and where appropriate decrypt it;
play back the image and/or the sound of the digital content or TV program received by means incorporated in or connected to the portable electronic device.

61. A system for broadcasting digital contents or TV programs within a premises or transport means, the system comprising:
a system according to claim 32 arranged to broadcast a digital stream via a wireless communication interface;
at least one other electronic device connectable via at least one standard interface for playing back a video image and/or the associated sound;
a receiver interface connected to the at least one other standard electronic device for playing back a video image and the associated sound, the receiver interface being arranged:
to receive the digital information stream broadcast by the apparatus;
to decode the received information, and where appropriate decrypt it; and
to play back the image and the sound of the digital content or television program received via the at least one other standard electronic device connected thereto for playing back a video image and/or the associated sound.

62. A system according to claim 60, further comprising a direct or indirect connection to a broadband infrastructure network to acquire therefrom television programs and/or video and/or musical content streams.
